(19) United States
(12) Patent Application Publication
(10) Pub. No.: US 2012/0174716 A1
(43) Pub. Date: Jul. 12, 2012

(54) INSULATED RATCHET WRENCH

(76) Inventor: Cheng-Chang Tsai, Taichung (TW)

(21) Appl. No.: 13/004,876

(22) Filed: Jan. 11, 2011

(51) Int. Cl. B25B 13/46; B25B 23/18

(52) U.S. Cl. 81/60; 81/63.1

(57) ABSTRACT

An insulated ratchet wrench comprising a body and an insulated coat coated with an outer periphery of the body. The body is divided into a head and a handle and a through hole is defined in the head for mounting a ratchet device. The ratchet device includes a polygonal stub extending therefrom and passing through the insulated coat for connecting to a workpiece. An actuator extends through the insulated coat and the through hole for partially and moved received in the polygonal stub. The insulated coat includes an enlarged portion for coating the head. A recess is defined in the enlarged portion for movably receiving the actuator and a through hole is defined in a bottom of the recess to allow the actuator extending through the insulated coat.

### BACKGROUND OF THE INVENTION

1. Field of the Invention

The present invention relates to a wrench, and more particularly to an insulated ratchet wrench.

2. Description of Related Art

As usual, a wrench needs a heavy structure such that most of the wrenches are made of alloy. However, alloy is a good conductor so that the operator is under a danger of an electric shock. As a result, some wrench is coated with an insulated layer, such as rubber or plastic. However, the insulated layer only coats a holding portion of the conventional wrench and most of the periphery of the wrench is exposed. The problem of electric shock is not completely solved.

The present invention has arisen to mitigate and/or obviate the disadvantages of the conventional ratchet wrench.

### SUMMARY OF THE INVENTION

The main objective of the present invention is to provide an improved ratchet wrench that is completely insulated.

To achieve the objective, the insulated ratchet wrench in accordance with the present invention comprises a body and an insulated coat coated with an outer periphery of the body. The body is divided into a head and a handle and a through hole is defined in the head for mounting a ratchet device. The ratchet device includes a polygonal stub extending therefrom and passing through the insulated coat for connecting to a workpiece. An actuator extends through the insulated coat and the through hole for partially and moved received in the polygonal stub. The insulated coat includes an enlarged portion for coating the head. A recess is defined in the enlarged portion for movably receiving the actuator and a through hole is defined in a bottom of the recess to allow the actuator extending through the insulated coat.

The insulated ratchet wrench in accordance with the present invention is put into a test trough when testing the insulated effect thereof, wherein the test trough is filled with electrified steel ball. The actuator completely closes the first recess when the actuator is upwardly moved relative to the enlarged portion of the insulated coat to separate the ratchet device from the electrified steel balls and prevent the electrified steel balls entering the through hole in the head such that a condition of jump power is prevented.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of an insulated ratchet wrench in accordance with the present invention;

FIG. 2 is an exploded perspective view of the insulated ratchet wrench in FIG. 1;

FIG. 3 is a partial top plan view of the insulated ratchet wrench in FIG. 1; and

FIG. 4 is a cross-sectional view of the insulated ratchet wrench when being under a conducting test.

### DETAILED DESCRIPTION OF THE INVENTION

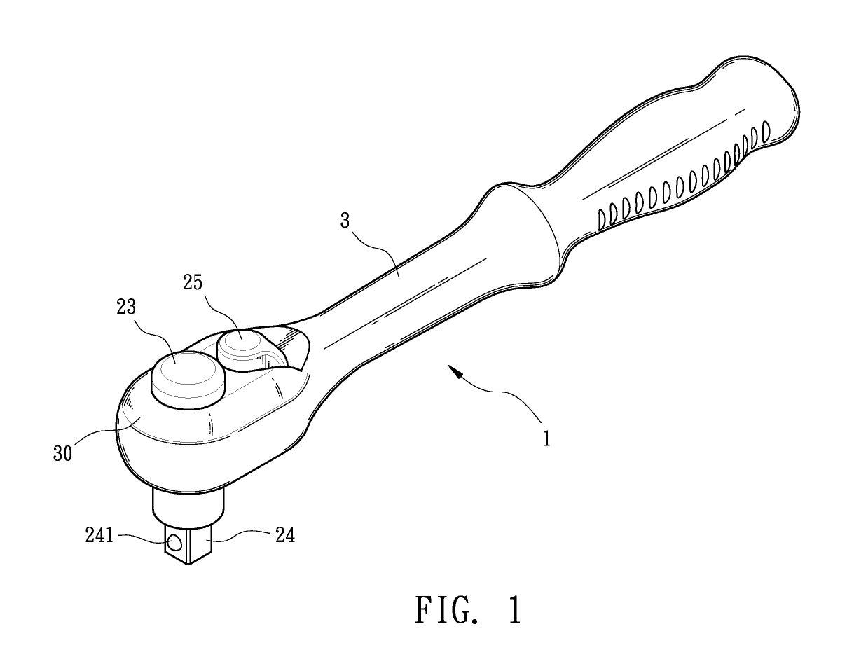

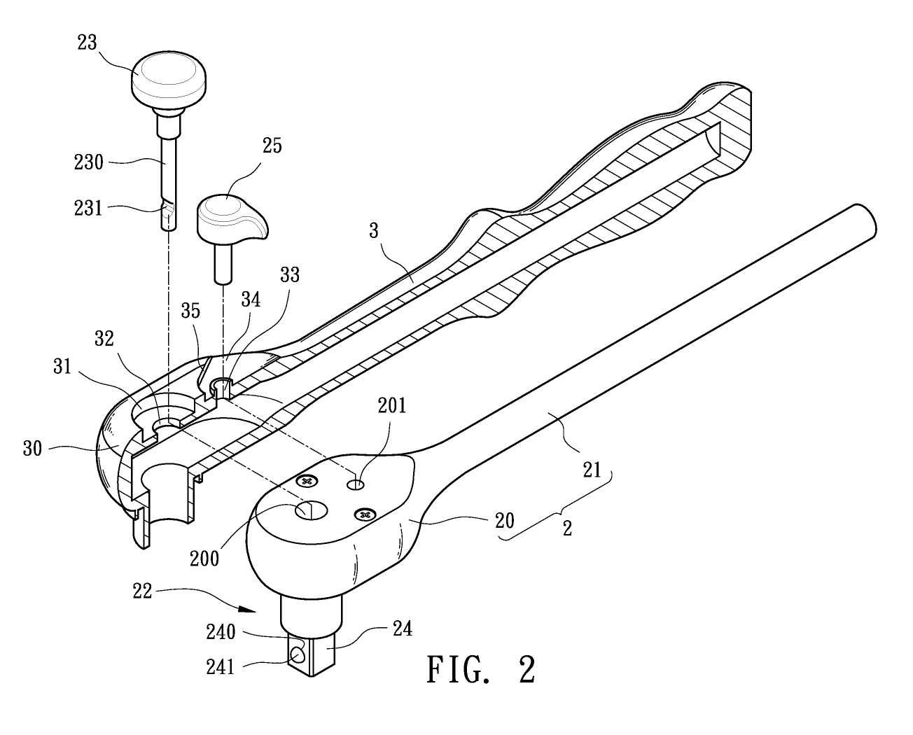

Referring to the drawings and initially to FIGS. 1-3, an insulated ratchet wrench 1 in accordance with the present invention comprises body 2 and an insulated coat 3 coated with an outer periphery of the body 2.

The body 2 includes a head 20 and a handle 21 extending from the head 20. The head 12 includes a through hole 200 defined therein for mounting a ratchet device 22. The ratchet device 22 includes polygonal stub 24 longitudinally extending therefrom through the insulated coat 3, and an actuator 23 extending through the insulated coat 3 and co-axially extending into the polygonal stub 24, wherein the actuator 23 is made of insulated material and reciprocally longitudinally moved relative to the polygonal stub 24. The actuator 23 includes a shaft 230 centrally extending therefrom and passing through the through hole 200 to be movably received in the polygonal stub 24. An indentation 231 is laterally defined in the shaft 23. The polygonal stub 24 has a dimple 240 laterally defined therein and a steel ball 241 is movably received in the dimple 240 for selectively engaged to a workpiece not shown. The indentation 231 communicates with the dimple 240 to make the steel ball 241 moved back into the polygonal stub 24 and disengaged with the workpiece when the actuator 23 is pressed. The head 20 includes a cavity 201 defined therein for rotatably mounting a selector 25 that is rotated to select an operational direction of the ratchet device 22.

The insulated coat 3 includes an enlarged portion 30 for coating the head 20. A first recess 31 is defined in the top of the enlarged portion 30 for receiving the actuator 23, wherein the actuator 23 completely closing the first recess 31. A first through hole 32 is centrally defined in a bottom of the first recess 31 and communicating with the through hole 200 to allow the shaft 230 extending through the insulated coat 3.

A second recess 34 is defined in the enlarged portion 30 and corresponds to the cavity 201, wherein the second recess 34 has a V-shaped horizontal cross-section and forms with two stoppers 35 for limiting the rotary range of the selector 25. A second through hole 33 is defined in a bottom of the second recess 34 and aligns with the cavity 201 to allow the selector 25 extending the insulated coat 3 and operating the ratchet device 22.

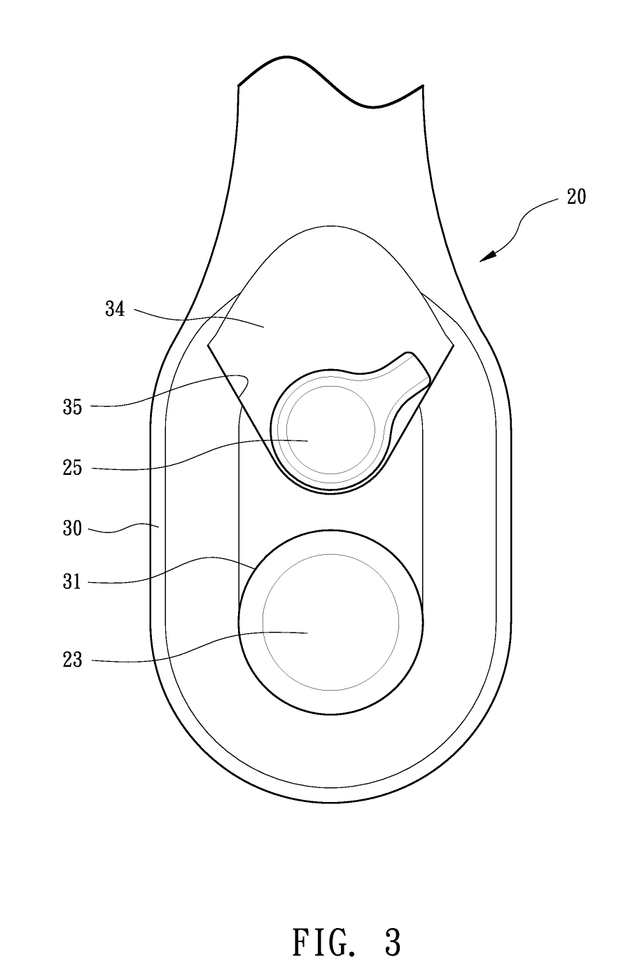

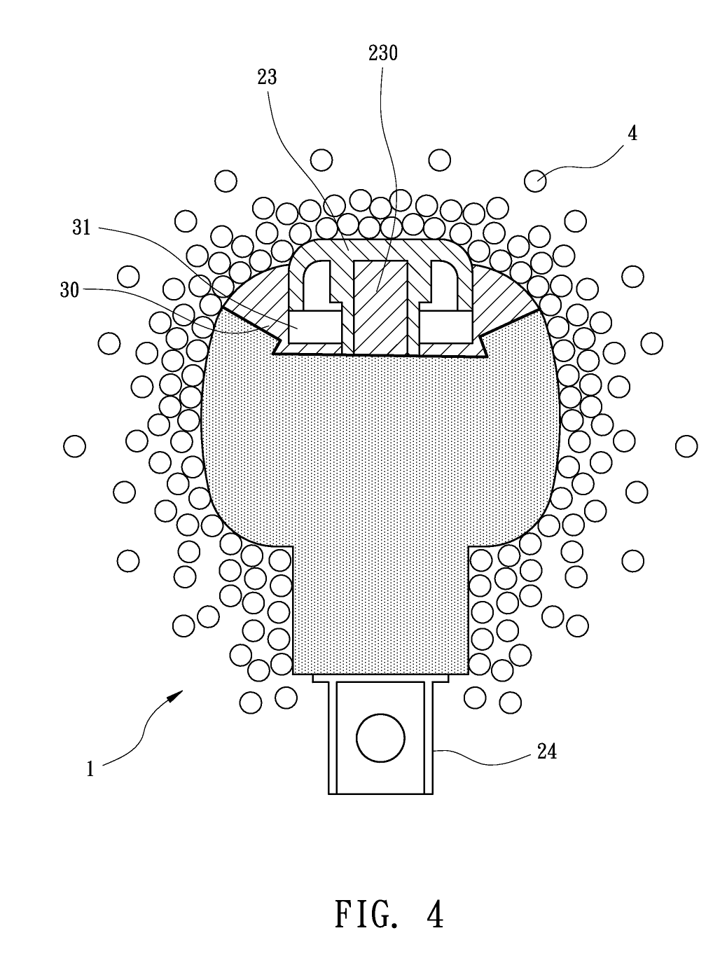

With reference to FIGS. 3 and 4, the insulated ratchet wrench 1 in accordance with the present invention is put into a test trough that is filled with electrified steel balls 4. The actuator 23 completely closes the first recess 31 when the actuator 23 is upwardly moved relative to the enlarged portion 30 of the insulated coat 3 to separate the ratchet device 22 from the electrified steel balls 4 and prevent the electrified steel balls 4 entering the through hole 200 in the head 20 such that a condition of jump power is prevented.

Although the invention has been explained in relation to its preferred embodiment, it is to be understood that many other possible modifications and variations can be made without departing from the spirit and scope of the invention as hereinafter claimed.

What is claimed is:

1. An insulated ratchet wrench comprising a body and an insulated coat coated with an outer periphery of the body, wherein:
the body is divided into a head and a handle, a through hole defined in the head for mounting a ratchet device, the ratchet device including a polygonal stub extending therefrom and passing through the insulated coat, the polygonal stub adapted to be connected to a workpiece, an actuator extending through the insulated coat and the through hole for partially and moved received in the polygonal stub; and
the insulated coat includes an enlarged portion for coating the head, a first recess defined in the enlarged portion for movably receiving the actuator and a first through hole defined in a bottom of the first recess to allow the actuator extending through the insulated coat.

2. The insulated ratchet wrench as claimed in claim 1, wherein the head includes a cavity defined therein for mounting a selector that controls an operational direction of the ratchet device.

3. The insulated ratchet wrench as claimed in claim 2, wherein the enlarged portion of the insulated coat includes a second recess defined therein and corresponding to the cavity, the second recess having a horizontal cross-section and formed with two stopper for limiting a rotary range of the selector, a second through hole defined in a bottom of the second recess and communicating with the cavity to allow the selector extending into the head to control the ratchet device.
